(19) United States
(12) Patent Application Publication
(10) Pub. No.: US 2015/0370903 A1
(43) Pub. Date: Dec. 24, 2015

(54) Delivering Personalized Information

(71) Applicant: Google Inc., Mountain View, CA (US)

(72) Inventor: Donald Geoffrey Schuller, San Jose, CA (US)

(21) Appl. No.: 14/311,471

(22) Filed: Jun. 23, 2014

(51) Int. Cl. G06F 17/30

(52) U.S. Cl. CPC G06F 17/30867; G06F 17/30241; G06F 17/30528

(57) ABSTRACT

Systems, device and techniques are disclosed for providing an information card to the user based on determining that current location is a unique location and based a determined mode of arrival. The determination that a current location is a unique location may be based on a location history determined based on a user account or a device log. The information card may also be generated based on a user history or a user selection and may provide information about an establishment or travel directions. The information card may contain predictive information.

### BACKGROUND

Generally, when a traveling user arrives at a new location, the user has to search for establishments by accessing her mobile device and requesting information based on her current location. The information provided to the user is typically based only on the user's location. A user may not be aware of establishments that are beneficial to the user unless the user specifically searches for the establishment. As an example, a traveling user that arrives in a new state may have to access her mobile device and search for food establishments based on her current location. The user may then have to further filter the results based on the type of cuisine and what establishments are currently open.

### BRIEF SUMMARY

According to implementations of the disclosed subject matter, a current location of a user may be received. A determination may be made that the current location is a unique location based on, for example, a location history determined based on a user account or a device log. A mode of arrival may also be determined and an information card may be generated based on the current location and the mode of arrival. The information card may be provided to the user via a vehicle display, a vehicle speaker, a mobile device display, a mobile device speaker, or the like. The information card may further be based on a user preferences that is based on a user history or a user selection.

According to implementations of the disclosed subject matter, a means to receive a current location of a user may be provided. Means to determine whether the current location is unique location may also be provided and may be based on, for example, a location history determined based on a user account or a device log. A mode of arrival may also be determined and an information card may be generated based on the current location and the mode of arrival. The information card may be provided to the user via a vehicle display, a vehicle speaker, a mobile device display, a mobile device speaker, or the like. The information card may further be based on a user preferences that is based on a user history or a user selection.

Systems and techniques according to the present disclosure allow providing an information card based on a current location and a mode of arrival. Additional features, advantages, and implementations of the disclosed subject matter may be set forth or apparent from consideration of the following detailed description, drawings, and claims. Moreover, it is to be understood that both the foregoing summary and the following detailed description include examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example process for generating an information card, according to an implementation of the disclosed subject matter.

FIG. 2 shows a mode of arrival according to an implementation of the disclosed subject matter.

FIG. 3 shows another mode of arrival, according to an implementation of the disclosed subject matter.

FIG. 4 shows an example information card, according to an implementation of the disclosed subject matter.

FIG. 5 shows a computer according to an implementation of the disclosed subject matter.

FIG. 6 shows a network configuration according to an implementation of the disclosed subject matter.

### DETAILED DESCRIPTION

Techniques disclosed herein enable generating and providing an information card to a user. A current location of a user may be received and a determination may be made that the current location is a unique location. A mode of arrival (e.g., via car, plane, train, motorcycle, bicycle, on foot, etc.) may be determined based on speed and/or account information (e.g., emailed itinerary). The information card may be generated based on at least the current location and the mode of arrival, if the current location is a unique location. A unique location may be a location that is unfamiliar to a user such that the user may not have visited the location before or may not have visited the location for a threshold amount of time. The information card may be provided to a user via a vehicle or mobile device. As an example, a user may be driving and may arrive at New York City around the user's usual dinner time. The user's GPS coordinates may be provided by her car, and the coordinates may be compared to the car's travel history to determine that the car has never been in New York City. Additionally, the car's speed records may indicate that the user has been traveling at an average speed of 40 mph for the previous hour. It may be inferred that the use was traveling by car based on the average speed. An information card may be generated based on the user's unique current location being New York City and the user arriving by car. The information card may contain Ethiopian restaurants that are within three blocks of the user based on the likelihood that the user is hungry given the car ride and the user's preference of Ethiopian food. The Ethiopian restaurant may be selected based on previous search and selection of Ethiopian restaurants for dinner, by the user.

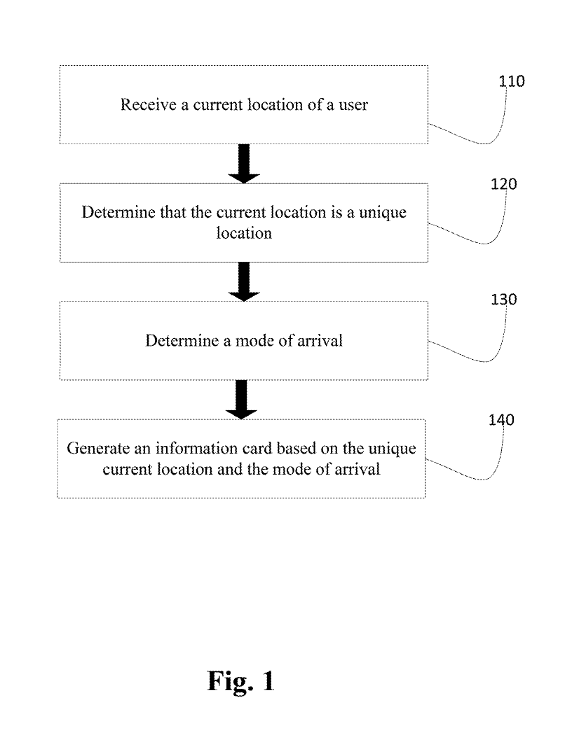

According to an implementation of the disclosed subject matter, as shown in FIG. 1 at step 110, a current location of a user may be received. The current location may be based on a component such as a mobile phone, a tablet, a laptop, a vehicle component, a GPS sensor, or the like. The current component may be independent or may be part of a mobile device or vehicle. As an example, a GPS sensor may be an independent GPS sensor or a GPS receiver inside a mobile phone. The component may provide any location based information such as GPS coordinates, Wi-Fi data, cellular data and the information may enable determination or triangulation of the user's location. As an example, a user's current location may be determined based on the user's car's GPS sensor receiving satellite data to identify GPS coordinates corresponding to the vehicle.

According to an implementation of the disclosed subject matter, as shown in FIG. 1 at step 120, a determination may be made that the current location of the user is a unique location. The determination may be made based on a use account, a device log, or the like.

A user account may be a user's subscription to a service. The service may be an online service or a local service. The service may be a messaging service (e.g., email, SMS service, in-application messaging service, etc.), a scheduling service (e.g., calendar, task list, etc.), a website, a blog, historical location storing service, or the like. As an example, a user's email account may contain information about the locations that a user has sent or received emails from. As another example, a user may opt to store location information (e.g., store location information associated with images that the user takes via her mobile phone). A record of the locations may be kept and used to determine whether a user's current location is a unique location. Location information about the user may be stored locally in a database, memory, server, or the like. Alternatively or in addition, location information about the user may be stored remotely in a remote database, memory, server, cloud server, or the like

A device log may correspond to locations that a device has logged as being active or present. The device may be a user's vehicle, mobile device, or independent component. As an example, a user's vehicle may keep or access a log of the locations that the vehicle has been. As another example a user's mobile device may keep or access a log of where the mobile device has connected to a cellular or Wi-Fi connection. The log may be stored locally in a database, memory, server, or the like. Alternatively or in addition, the log may be stored remotely in a remote database, memory, server, cloud server, or the like.

According to an implementation of the disclosed subject matter, a current location may correspond to one or more of GPS coordinates, an establishment, a landmark, an address, a zip-code, a city, a state, a country, or the like. An establishment may be a specific business, type of business, residence, attraction, or the like.

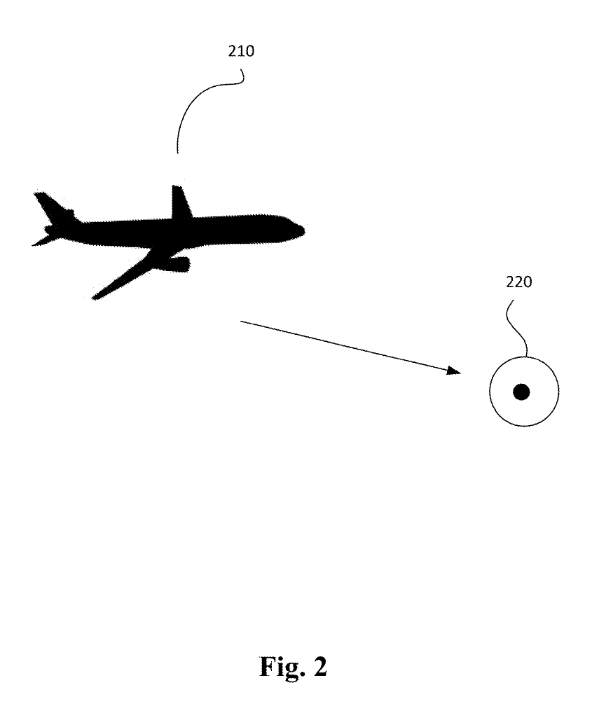

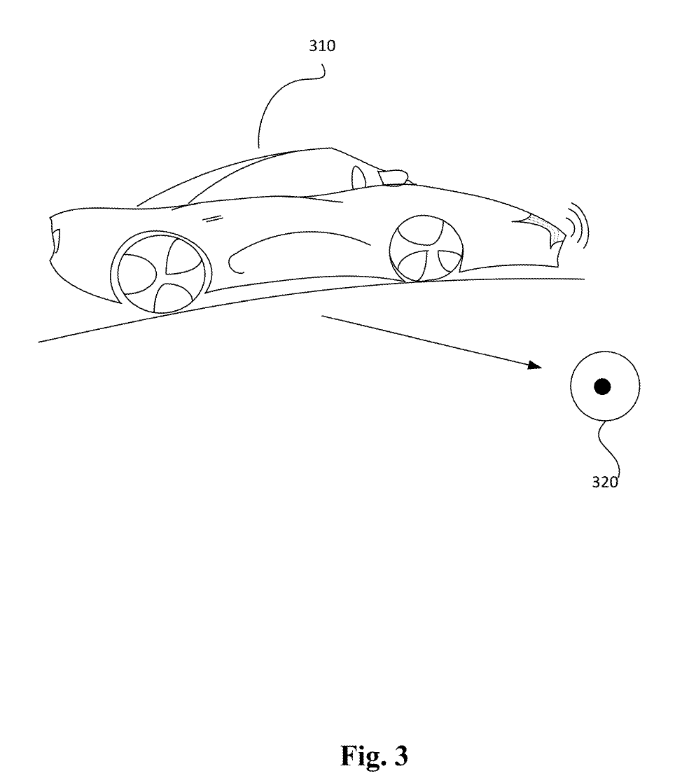

According to an implementation of the disclosed subject matter, as shown at step 130 in FIG. 1, a mode of arrival may be determined. The mode of arrival may correspond to a type of vehicle (e.g., car, train, plane, bicycle, etc.), or the type of activity the user conducted to arrive at a location (e.g., walk, jog, run). The mode of arrival may be determined based on a travel speed or a user account data. A travel speed may be calculated based one or more of an accelerometer, a speed log, a change in GPS coordinates, triangulation, or the like. As an illustrative example, as shown in FIG. 2, an airplane 210 may pass a current location 220. Based on an reading from an altimeter, the reading corresponding to 18000 feet, the current mode of transportation may be determined to be an airplane. As another illustrative example of a user's travel speed, as shown in FIG. 3, a user's vehicle 310 may arrive at location 320 while traveling at a speed of 60 mph (e.g., the current location 320 may correspond to a portion of a highway). Based on the user's travel speed of 60 mph, the mode of arrival may be determined to be a car. As disclosed herein, a user account may be a user's subscription to a service. The service may be an online service or a local service. The service may be a messaging service a website, a blog, historical location storing service, or the like. The service may contain information corresponding to the mode of transportation. As an example, if a user receives an email confirmation of a rental car pickup, then the mode of arrival subsequent to the rental car pickup may most likely be the rental car.

According to an implementation of the disclosed subject matter, as shown in FIG. 1 at step 140, an information card may be generated based on the unique current location and the mode of arrival.

The unique current location may be a factor when generating an information card. The current location may be used such that one or more other locations (e.g., GPS coordinates, an establishment, a landmark, etc.) may be identified based on the current location. The one or more other locations may be proximate to the current location such that the information regarding the one or more other locations can benefit the user. As an example, if the unique location is a country that the user has never visited before, landmarks such as monuments and/or museums may be provided to the user via the information card. The landmarks may be listed based on the proximity of the landmark to the unique current location.

The mode of arrival may be a factor when generating in information card. The mode of arrival may be used such that one or more locations (e.g., GPS coordinates, an establishment, a landmark, etc.) may be identified based on the mode of arrival. Different modes of arrival may have unique attributes associated with them. The unique attributes may provide a more relevant identification of another location for the user. As an example, if the mode of arrival is a car, then the user may be presented with an information card containing data about other locations that are within a 4 mile radius. The 4 mile radius may be applied with the assumption that the user most likely has access to the car and drive to a location within 4 miles. As another example, if the mode of arrival is a car, then the user may be presented with gas stations that are proximate to the current unique locations. This information may be provided via an information card especially if an indication that the car is low on gas is received. As another example, if the mode of arrival is an airplane, then the user may be presented with taxi cab stands or hotel information based on the likelihood that the user will need those services.

An information card may contain any information that is likely to benefit a user such as data corresponding to an establishment (e.g., price, menu items, inventory, services provided, historical facts, known figures, unique facts, etc.), travel directions (e.g., to an establishment, to a destination, to an identified location of interest, etc.), weather information, current events information, predictive information or the like. As an example, a user that arrives in New York City may receiving a list of landmarks, including the Empire State Building, that the user may wish to visit. Selection of a portion of the information card may result in more detailed information. Specifically, if the user selects the Empire State Building, the user may be provided with visiting hours, price, and Empire State building facts. Continuing the example, if the user selects the Empire State Building, then the user may be provided with travel directs to reach the Empire State Building. The travel directions may include walking directions, vehicle direction, public transportation directions, or the like.

According to an implementation of the disclosed subject matter, an information card may provide predictive information. The predictive information may contain a suggestion (e.g., a suggestion corresponding to a future time or event, an action based on current attributes, etc.). The predictive information may be generated based on user preferences, user activities, user account information, current attributes, or the like.

A user's preferences may be determined based on user selection or user history. User selections may be provided by a user via any applicable device such as a mobile device, vehicle, online service (e.g., website), application or the like. The use may provide the selection at a current time or may provide the selection prior to a current time. Examples of user selections may include user food preferences, user establishment preferences (e.g., 4 star hotel), user health, user demographics, user likes (e.g., music, hobbies, etc.), user dislikes, or the like. As an example, a user may access her service account on her laptop and access a preferences tab via the service account. The user may provide demographic information and user likes via the preference tabs. A user history may be based on actions or events associated with the user. Actions or events may include browsing information, purchase information, ticket purchases, travel, services performed or purchased, or the like. As an example, a list of the user's past concert ticket purchases may provide a user history corresponding to the user's musical taste preference.

User activities may correspond to communication made by the user, purchases made by the user, user habits (e.g., the user prefers to take a 30 minute break after driving for an average of 2.5 hours), user travel, or the like.

As disclosed herein, a user account may be a user's subscription to a service. The service may be an online service or a local service. The service may be a messaging service a website, a blog, historical location storing service, or the like. The service may contain information corresponding to the mode of transportation.

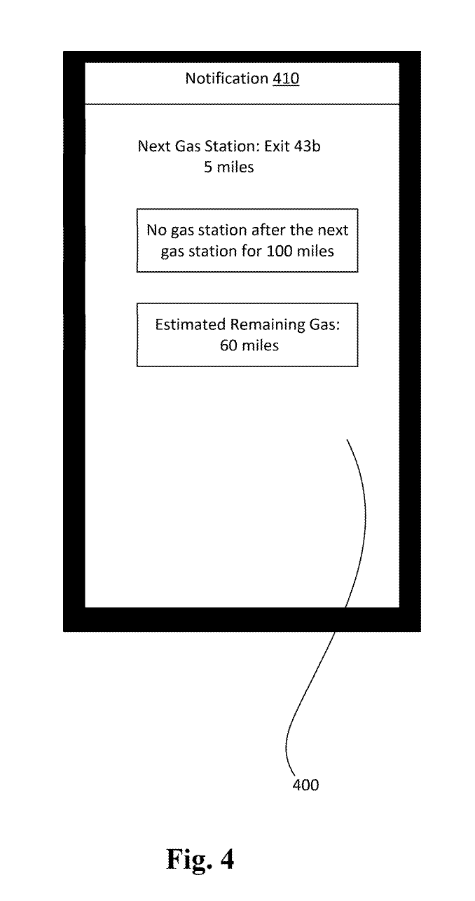

An information card containing predictive information may include information corresponding to a suggested action at a future time based on current attributes. As an example, if current attributes include a preference of Thai food (via a user account), a time of 7 PM, and a travel time of 4 hours, then the predictive information may suggest a Thai restaurant proximate to the unique current location. Here, the predictive information may entail a determination that the user has likely traveled for the last 4 hours and it is dinner time. Accordingly, a user preferred Thai cuisine may be selected and a proximate Thai restaurant may be provided for the user to visit for dinner. As another example, as shown in FIG. 4, an information card 400 may provide a notification 410 to a user. The notification may be based on the unique current location of a user corresponding to a highway containing exits. The predictive information component may determine that the user's car contains enough gas for 60 miles of travel and that the next gas station is at exit 43b in 5 miles. The information card may also indicate to the user that the gas station subsequent to the next gas station (in 5 miles) is in 100 miles. Accordingly, a user may be able to obtain gas at the gas station at exit 43b and prevent running out of gas.

As an example of a generated information card, user account information corresponding to a user's calendar may indicate that the user generally eats lunch around 12:00. The user may be traveling in her car at 11:30 and a determination may be made that given the intended path of travel (e.g., based on navigation), the user will pass a restaurant in 3 minutes. A subsequent restaurant that is of interest to the user (e.g., based on user's past eating habits), may not be available for another 2 hours. Accordingly, an information card may be provided to the user containing information regarding the upcoming restaurant even though it is not yet 12:00 (the user's usual lunch time).

Although shown for illustrative purposes as a dedicated user interface, an information card as disclosed herein also may be provided in any other suitable format or interface arrangement. For example, the information card may be provided through a smart phone notification system, application, an in-dash vehicle information system, text to speech format, or the like. Similarly, it may be provided as an audio-only alert, such as where a “driving” or “hands-free” mode is engaged on a mobile device or in-dash system, or the like.

According to an implementation of the disclosed subject matter, an information card may be provided via an output mode. An output mode may be via a vehicle display, a vehicle speaker, a mobile device display, a mobile device speaker, or the like. As disclosed, the information card may be any output to a user including a visual or auditory output such as a message, an update, dynamic directions, an interface, or the like. As an example, an information card corresponding to an upcoming gas station may be provided to the user via a navigation screen notification to enable a user to view the information card without having to look at her mobile device. Additionally, for example, the notification may be acoustically provided to the user via the vehicle's speaker system.

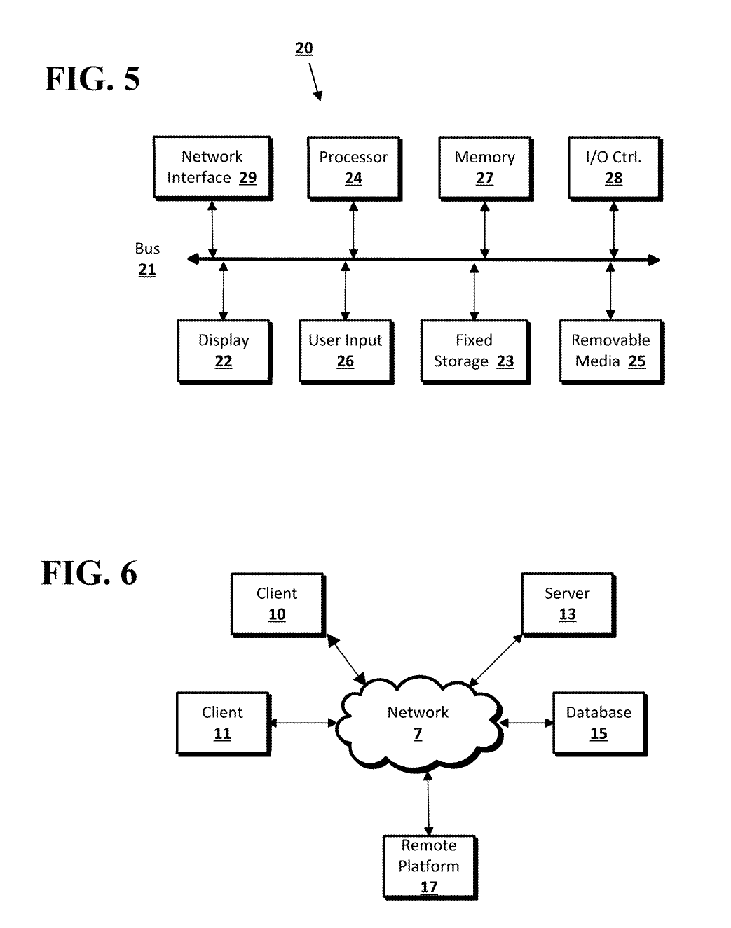

Implementations of the presently disclosed subject matter may be implemented in and used with a variety of component and network architectures. As an example, a mobile phone may be in connection with a cloud server and the cloud server may provide information to an event listener. FIG. 5 is an example computer 20 suitable for implementing implementations of the presently disclosed subject matter. The computer (e.g., mobile phone, tablet, laptop, etc.) 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 6.

Many other devices or components (not shown) may be connected in a similar manner (e.g., document scanners, digital cameras and so on). Conversely, all of the components shown in FIG. 5 need not be present to practice the present disclosure. The components can be interconnected in different ways from that shown. The operation of a computer such as that shown in FIG. 5 is readily known in the art and is not discussed in detail in this application. Code to implement the present disclosure can be stored in computer-readable storage media such as one or more of the memory 27, fixed storage 23, removable media 25, or on a remote storage location.

FIG. 6 shows an example network arrangement according to an implementation of the disclosed subject matter. One or more clients 10, 11, such as smart power devices, microcomputers, local computers, smart phones, tablet computing devices, and the like may connect to other devices via one or more networks 7 (e.g., a power distribution network). The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

In situations in which the implementations of the disclosed subject matter collect personal information about users, or may make use of personal information, the users may be provided with an opportunity to control whether programs or features collect user information (e.g., a user's performance score, a user's work product, a user's provided input, a user's geographic location, and any other similar data associated with a user), or to control whether and/or how to receive instructional course content from the instructional course provider that may be more relevant to the user. In addition, certain data may be treated in one or more ways before it is stored or used, so that personally identifiable information is removed. For example, a user's identity may be treated so that no personally identifiable information can be determined for the user, or a user's geographic location associated with an instructional course may be generalized where location information is obtained (such as to a city, ZIP code, or state level), so that a particular location of a user cannot be determined. Thus, the user may have control over how information is collected about the user and used by an instructional course provider.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
receiving a current location of a user;
determining that the current location is a unique location;
determining a mode of arrival;
based on determining that the current location is a unique location, generating an information card based on the current location and the mode of arrival;
providing the information card to the user.

2. The method of claim 1, wherein the current location is determined based on a device selected from the group consisting of: a mobile phone, a tablet, a laptop, a vehicle component, and a GPS sensor.

3. The method of claim 1, wherein the current location is determined based on one or more selected from the group consisting of: GPS coordinates, Wi-Fi source, and cellular triangulation.

4. The method of claim 1, wherein the current location is one selected from the group consisting of: GPS coordinates, an establishment, a landmark, an address, a zip-code, a city, a state, and a country.

5. The method of claim 1, wherein the determination that a current location is a unique location is based on a location history.

6. The method of claim 5, wherein the location history is based on one or more selected from the group consisting of: a user account and a device log.

7. The method of claim 1, wherein the mode of arrival is determined based on one or more selected from the group consisting of: a travel speed and a user account data.

8. The method of claim 1, further comprising generating the information card based on a user preference, the user preference selected from one or more from the group consisting of: a user history and a user selection.

9. The method of claim 1, wherein the information card is further generated based on one or more selected from the group consisting of: a time, a location, an establishment, and a current condition.

10. The method of claim 1, wherein the information card comprises information about an establishment.

11. The method of claim 1, wherein the information card comprises information about travel directions.

12. The method of claim 1, wherein the information card comprises predictive information.

13. The method of claim 12, wherein the predictive information comprises a suggested action at a future time, the suggested action based on current attributes of a user, setting, or events.

14. The method of claim 1, wherein the information card is provided via an output mode selected from the group consisting of: a vehicle display, a vehicle speaker, a mobile device display, a mobile device speaker.

15. A system comprising
a processor configured to:
receive a current location of a user;
determine that the current location is a unique location;
determine a mode of arrival;
based on determining that the current location is a unique location, generating an information card based on the current location and the mode of arrival;
provide the information card to the user.

16. The system of claim 15, wherein the information card comprises predictive information.

17. The system of claim 16, wherein the predictive information comprises a suggested action at a future time, the suggested action based on current attributes.
